(19) United States
(12) Patent Application Publication
(10) Pub. No.: US 2012/0125136 A1
(43) Pub. Date: May 24, 2012

(54) ARRANGEMENT FOR CREATING A SHIFTING FORCE OR SELECTION FORCE IN A MANUAL TRANSMISSION

(75) Inventor: Philipp Werdin, Berlin (DE)

(73) Assignee: ZF FRIEDRICHSHAFEN AG, Friedrichshafen (DE)

(21) Appl. No.: 13/128,729

(22) PCT Filed: Jan. 26, 2010
(86) PCT No.: PCT/EP2010/050834

§ 371 Date: May 11, 2011

(30) Foreign Application Priority Data
Feb. 13, 2009 (DE) 10 2009 000 858.6

(51) Int. Cl. F16H 59/02

(52) U.S. Cl. 74/473.3

(57) ABSTRACT

A device for producing a shifting force or a selection force in a manual-shift transmission for a motor vehicle. The device comprises a contour element (12) and a contour-following element that co-operates with the contour element (12), one of which is deflected against the force of a spring during shifting or selection movement of a manual-shift lever. The device comprises a contour control arrangement which is in drive connection with the manual-shift lever and which comprises a second contour element (14) and a second contour-following element (18) whose element, that is deflected during a shifting or a selection movement of the manual-shift lever, actuates a friction brake (31).

This application is a National Stage completion of PCT/EP2010/050834 filed Jan. 26, 2010, which claims priority from German patent application serial no. 10 2009 000 858.6 filed Feb. 13, 2009.

### FIELD OF THE INVENTION

The invention concerns a device for creating a shifting force or selection force in a manual transmission for motor vehicles.

### BACKGROUND OF THE INVENTION

Manual transmissions of motor vehicles are actuated by the driver using a manual shift lever which can be moved out of a rest position into a so-termed transverse gate or selector gate and into a number of shift gates perpendicular to the transverse gate, such that the rest position generally corresponds to a particular shift gate. Thus, a shifting process can consist on the one hand of a transverse movement for selecting a shift gate (also called selecting) and a longitudinal movement in a shift gate (shifting), by which a specific gearwheel of the shift transmission is brought into the power flow of the transmission.

To make it easier for the driver to correctly select the gears to be engaged, in the transmission selection and/or shifting forces are produced, which oppose the shift movement by the driver to a greater or lesser extent. The selection forces in particular enable the driver to distinguish in a tactile manner between the individual shift gates, usually by virtue of different selection forces for the individual gates. Below, for the sake of simplicity only the term “shifting” will be used for both movements, since in the context of the present invention they are equivalent and the device according to the invention described later on can be used alternatively for the production of both selection and shifting forces.

The selection and/or shifting forces are produced by separate devices, which are coupled with the manual-shift lever by connecting linkages or the like. DE 10 2004 060 056 A1 shows a device of the type in which a pivoting arm system carrying a contact roller is arranged on the shifting shaft connected to the manual-shift lever, in such manner that the contact roller rests in contact with a pivot-mounted, spring-loaded contour element. When the manual-shift lever undergoes shifting movement the shifting shaft is rotated, so that the contact roller moves along the contour element and deflects it to a greater or lesser extent, thereby producing greater or smaller shifting forces.

Particular shift gates, for example the gate for the reverse gear, in addition to a high shifting force, can be characterized by higher friction during the shifting movement. This friction gives rise to a hysteresis effect, i.e. when the shift gate concerned is selected both the selection force and the friction force act to oppose the selection movement, whereas the return movement out of the shift gate is assisted by the selection force. The hysteresis has the advantage that the selection forces for selecting the shift gate concerned are desirably large but the return forces are small.

As already described, the selection force or shifting force is produced by a varying deflection of an elastically prestressed contour element or contour-following element during the shifting or selection movement. The desired friction is generally produced between the contour element and the contour-following element, and depends on the spring force that is acting and on the friction properties between the contour element and the contour-following element. If the friction desired is large, this is achieved for example by providing for sliding friction but no rolling friction between the contour element and the contour-following element. Since both the shifting force or selection force and the friction force will then depend on the spring force acting, if a large friction force is desired this can only be produced in combination with a large shifting force, but this is not always desired. Besides, it has been shown that with the known arrangement, the friction force, which actually depends on the acting spring force and the chosen friction pairing, cannot be associated with accurately determined shifting or selection angles.

### SUMMARY OF THE INVENTION

Against this background the purpose of the present invention is to provide a device of the type mentioned, with which a defined friction can be produced as a function of the shifting or selection angle even in the case of low holding forces.

The invention is based on the recognition that a separation of the means for producing on the one hand the shifting force and on the other hand the friction force, makes it possible to produce defined friction forces independently of the shifting force or selection force.

Accordingly, the invention starts from a device for producing a shifting force or selection force in a manual transmission for motor vehicles, comprising a contour element and a contour-following element that co-operates with it, one of which is deflected against the force of a spring during a shifting or selection movement of a manual-shift lever. To achieve the stated objective, in this case it is provided that the device comprises a contour-control arrangement which comprises a second contour element and a second contour-following element and which is in drive connection with the manual-shift lever, such that the respective element thereof which is deflected during a shifting or selection movement of the manual-shift lever actuates a friction brake.

During a shifting or selection movement of the manual-shift lever, on the one hand a shifting or selection force is produced by the first contour element and the contour-following element associated with it, and on the other hand, independently of this, a friction force is produced by the second contour element and its associated contour-following element. By appropriate design of the contour-control arrangement in each case the shifting or selection force and the friction force can be determined independently of one another so that, for example, even when the shifting or selection force is small a relatively large friction force can be produced, or conversely.

To design the device as simply as possible, in one version of the invention it is provided that the first contour element and the second contour element are arranged on a common contour element carrier (supporting shaft) which is actively connected to the manual-shift lever and is displaced during a shifting or selection movement, and the second contour element co-operates with a contour-following element, the contour element being deflected during a shifting or selection movement and actuating the friction brake.

According to a preferred design of the invention the contour element carrier is in the form of a supporting shaft mounted to rotate in a positionally fixed housing, one end of which is in drive connection with the manual-shift lever and at the other end of which are arranged the two contour elements which are displaced when the supporting shaft is rotated, as will be shown more clearly with reference to an example embodiment.

A further design feature of the invention provides that the supporting shaft is mounted in the housing with axial play, and that on the supporting shaft on the one hand and on the housing on the other hand, co-operating friction surfaces are provided which can be brought into braking contact by an axial movement of the supporting shaft relative to the housing in a first axial direction, and can be moved out of braking contact by a movement in the opposite direction, and the second contour-following element is elastically supported against the housing in such manner that when the second contour element is displaced relative to the housing the supporting shaft is pushed in the first axial direction so that the friction surfaces are brought into braking contact.

Accordingly, the supporting shaft has two functions, in that on the one hand it carries the two contour elements and displaces them when the supporting shaft is rotated about its longitudinal axis, and on the other hand it is part of the friction brake, which is activated or released by moving the supporting shaft in the direction along its longitudinal axis.

According to a further design feature of the invention, the second contour-following element is in the form of a spring bolt parallel to the longitudinal axis of the supporting shaft and supported elastically against the housing. When the second contour element is displaced, for example from a specified shifting or selection angle onward the spring acting on the spring bolt is compressed and thus reinforces the braking force by virtue of the reaction force that acts upon the contour element.

Preferably, the spring bolt comprises a sleeve arranged fixed on the housing and open toward the associated contour element, and a pressure element fitted and able to move in the sleeve, which is prestressed in the direction toward the contour element by a compression spring located in the sleeve. For its part, the pressure element consists of a piston that can move axially in the sleeve on the side of this facing toward the contour element, and a ball fitted so that it can roll and is in contact with the contour element. Thus, the second contour element and its associated contour-following element co-operate with rolling friction between them, so that they are essentially not involved so far as the desired friction force is concerned. The latter is produced only by the friction brake.

A further design feature of the invention provides that the friction surface on the supporting shaft is formed by an outer conical section formed thereon, and the friction surface of the housing is formed by a ring with an inner cone complementary to the outer conical section arranged in a housing bore that receives the supporting shaft. Regardless of the material of the housing, the ring forming the inner cone can therefore be chosen such that, together with the outer conical section of the supporting shaft, a suitable friction pairing is obtained.

A design feature of the supporting shaft provides that at its end on the drive input side is arranged an outer actuating lever coupled to the manual-shift lever by connecting means, by means of which it is rotated during a shifting or selection movement, whereas at the end of the supporting shaft on the drive output side is arranged a two-arm actuating lever on one end of which is arranged the first contour element and on the second end of which is arranged the second contour element.

### BRIEF DESCRIPTION OF THE DRAWINGS

The invention can be explained further with reference to an example embodiment. For this purpose the description of a drawing is attached, which shows:

FIG. 1: Longitudinally sectioned view of a device for producing a selection force, and

FIG. 2: A detail of FIG. 1

### DETAILED DESCRIPTION OF THE PREFERRED EMBODIMENTS

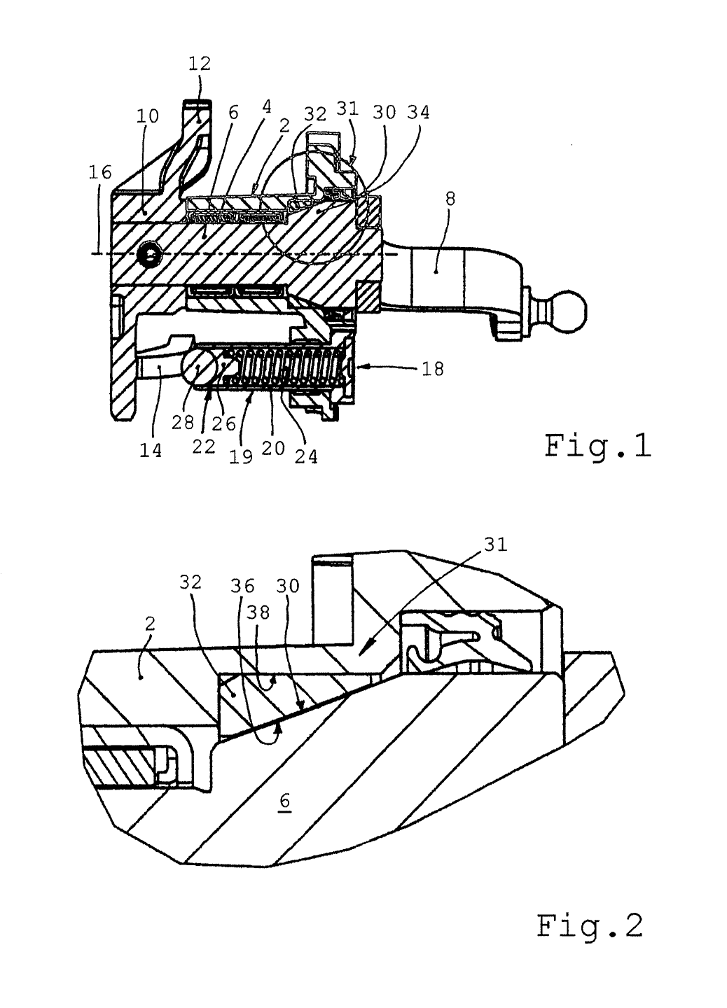

The device for producing a selection force represented in FIG. 1 comprises a housing 2, for example arranged fixed in a transmission arrangement, and a supporting shaft 6 mounted by means of a double-row needle bearing 4 to rotate therein, at the drive input end of which, namely on the right in FIG. 1, is arranged an outer actuating lever 8. At the opposite end of the supporting shaft 6 on the drive output side, namely on the left in FIG. 1, is attached a two-arm, inner actuating lever 10, on one end of which is arranged a first contour element 12 and on the other end of which is arranged a second contour element 14.

On the housing 2 is arranged a contour-following element 18, which is formed by a spring bolt 19 parallel to the longitudinal axis 16 of the supporting shaft 6, this element 18 being formed of a sleeve 20 open toward the second contour element 14, a pressure element 22 fitted and able to move axially therein, and a spring 24 which pushes the pressure element 22 toward the contour element 14. The pressure element 22 consists of a piston 26 and, on the side thereof facing toward the contour element 14, a ball 28 fitted so that it can roll.

The supporting shaft 6 is fitted in the housing 2 with axial play, so that it can move slightly in the axial direction. On the supporting shaft 6 is formed an outer conical section 30 which co-operates with an inner cone 36 of shape complementary to that of the outer cone section 30, on a ring 32 arranged in the housing bore that holds the supporting shaft 6. The outer conical section 30 and the inner cone of the ring 32 are made as friction surfaces and form a friction brake 31. The function of this device is as follows:

When the manual-shift lever undergoes a selection movement, the movement is transmitted by connecting means (not shown) to the outer actuating lever 8, whereby the supporting shaft 6 is rotated about its longitudinal axis 16. During this, on the one hand a selection force is produced in a manner known per se by the first contour element 12 and a contour-following element (not shown) that co-operates with it.

At the same time, by means of the second contour element 14 and the spring bolt 19 in elastic contact with it, for example from a specified selection angle onward a force which pushes the supporting shaft 6 to the left in FIG. 1 is produced, which activates the friction brake formed of the outer conical section 30 and the inner cone 36 of the ring 32 when they are brought into braking contact, whereby a friction force is produced which is determined by the shape of the second contour element 14 and depends on the rotation angle of the supporting shaft 6 and hence on the selection movement path. This friction force is independent of the selection force determined by the contour of the first contour element. It can be determined accurately by choosing the cone angle and the friction pairing.

FIG. 2 shows an enlarged view of the part of FIG. 1 enclosed within the circle 34. The figure shows the outer conical section 30 of the supporting shaft 6 and the ring 32 with the inner cone 36 formed on it, arranged in a corresponding recess 38 of the housing 2.

### INDEXES

2 Housing
4 Needle bearing
6 Supporting shaft; contour element carrier
8 Outer actuating lever
10 Inner actuating lever
12 First contour element
14 Second contour element
16 Longitudinal axis
18 Contour-following element
19 Spring bolt
20 Sleeve
22 Pressure element
24 Spring
26 Piston
28 Ball
30 Outer conical section
32 Ring
34 Circle
36 Inner cone
38 Recess

1-9. (canceled)

10. A device for producing either a shifting force or a selection force in a manual-shift transmission for a motor vehicle, the device comprising:
a first contour element (12) and a contour-following element co-operating with the first contour element (12),
one of the first contour element (12) and the contour-following element being deflected against a force of a spring during either a shifting or a selection movement of a manual-shift lever,
a contour control arrangement being in drive connection with the manual-shift lever and comprising a second contour element (14), and
a second contour-following element (18) being deflected, during the shifting or the selection movement of the manual-shift lever, for actuating a friction brake (31).

11. The device according to claim 10, wherein the first contour element (12) and the second contour element (14) are arranged on a common contour element carrier which is actively connected to the manual-shift lever and is displaced, during the shifting or the selection movement, and the second contour element (14) co-operates with the contour-following element (18) which, during the shifting or the selection movement, is deflected and actuates the friction brake (31).

12. The device according to claim 11, wherein the contour element carrier is a supporting shaft (6) mounted for rotation in a fixed housing (2), a first end of the supporting shaft (6) is in drive connection with the manual-shift lever and the first and the second contour elements (12, 14), which are displaced when the supporting shaft (6) is rotated, are arranged on an opposite end of the supporting shaft (6).

13. The device according to claim 12, wherein the supporting shaft (6) is mounted in the housing (2) with axial play, a first friction surface is provided on the supporting shaft (6) and a second friction surface is provided on the housing (2), the first and the second friction surfaces are brought into braking contact by axial movement of the supporting shaft (6) relative to the housing (2), in a first axial direction, along a longitudinal axis (16) and out of braking contact by movement, in an opposite axial direction, and the second contour-following element (18) is elastically supported on the housing (2) such that when the supporting shaft (6) is rotated, due to the shifting or the selection movement, the supporting shaft (6) is pushed relative to the housing (2) in the first axial direction.

14. The device according to claim 13, wherein the second contour-following element (18) is a spring bolt (19) which extends parallel to the longitudinal axis (16) of the supporting shaft (6) and supported elastically on the housing (2).

15. The device according to claim 14, wherein the spring bolt (19) comprises a sleeve (20) fixed to the housing (2) and open toward the second contour element (14), and a pressure element (22) is fitted into and axially movable in the sleeve (20), and the pressure element (22) is prestressed in a direction toward the second contour element (14) by a spring (24) arranged inside the sleeve.

16. The device according to claim 15, wherein the pressure element (22) comprises a piston (26) that is movable within the sleeve (20) and a ball (28), on a side of the piston (26) facing the second contour element (14), is fitted and rolls in contact with the second contour element (14).

17. The device according to claim 12, wherein the friction surface on the supporting shaft (6) is formed by an outer conical section (30) formed thereon, and the friction surface of the housing (2) is formed by a ring (32) arranged in a housing bore that holds the supporting shaft (6), and the ring (32) has an inner cone (36) which is complementary to the outer conical section (30).

18. The device according to claim 10, wherein an outer actuating lever (8), coupled by connection means to the manual-shift lever, is arranged on a drive input side end of the supporting shaft (6), and a two-arm, inner actuating lever (10), which has the first contour element (12) at one end and the second contour element (14) at the second end thereof is arranged on a drive output side end of the supporting shaft (6).

19. A device for producing a shifting force in a manual transmission of a motor vehicle, the device comprising:
a first contour element (12) and a first contour-following element co-operating therewith;
one of the first contour element (12) and the first contour-following element being deflected against a force of a spring during shifting movement of a manual-shift lever;
a contour control arrangement being in drive connection with the manual-shift lever and comprising a second contour element (14) and a second contour-following element (18); and
one of the second contour element (14) and the second contour-following element (18) being deflected during the shifting movement of the manual-shift lever to actuate a friction brake (31).
